(19) United States
(12) Patent Application Publication
(10) Pub. No.: US 2012/0074813 A1
(43) Pub. Date: Mar. 29, 2012

(54) ULTRASONIC MOTOR DEVICE

(75) Inventor: Hiroyuki TAKIZAWA, Tokyo (JP)

(73) Assignee: OLYMPUS CORPORATION, Tokyo (JP)

(21) Appl. No.: 13/251,542

(22) Filed: Oct. 3, 2011

Related U.S. Application Data
(63) Continuation of application No. PCT/JP2010/055247, filed on Mar. 25, 2010.

(30) Foreign Application Priority Data
Apr. 1, 2009 (JP) JP 2009-088900

(51) Int. Cl. H02N 2/00

(52) U.S. Cl. 310/323.17

(57) ABSTRACT

Provided is an ultrasonic motor device which is easy to downsize and superior in assembling workability. The ultrasonic motor device includes a first ultrasonic motor unit and a second ultrasonic motor unit each of which includes: a vibrator which periodically vibrates; a case which accommodates the vibrator; a moving member which is in contact with the vibrator; and a biasing member which applies a pressing force to the moving member and the vibrator to bring the moving member and the vibrator into pressing contact with each other; a base member to which the case of the first ultrasonic motor unit is fixed; a first frame which is fixed to the moving member of the first ultrasonic motor unit and to which the case of the second ultrasonic motor unit is fixed; and a second frame which is fixed to the moving member of the second ultrasonic motor unit.

### TECHNICAL FIELD

The present invention relates to an ultrasonic motor device.

### BACKGROUND ART

Examples of conventional ultrasonic devices include an X-Y stage disclosed in Patent Document 1. This X-Y stage is an X-Y stage which includes a fixed stage, a movable stage that linearly reciprocatively moves relative to the fixed stage, and an ultrasonic linear motor provided on either the fixed stage or the movable stage. The ultrasonic linear motor is provided with at least two leg portions orientated in a moving direction of the movable stage, a body portion which connects ends of the leg portions, and a vibration source for vibrating the leg portions and the body portion. The ultrasonic linear motor is installed with the other ends of the leg portions pressed against the other of the fixed stage and the movable stage.

In addition, the stage device disclosed in Patent Document 2 is composed of a base in the shape of a flat plate, a first stage mounted on the base and driven by a first ultrasonic motor, and a second stage mounted on the first stage and driven by a second ultrasonic motor, and the cross roller guides are configured from V-shaped grooves, guide rails and others.

### RELATED ART DOCUMENTS

### Patent Documents

Patent Document 1: Japanese Patent No. 2506170 (patent specification)

Patent Document 2: Japanese Unexamined Patent Application Publication No. 2000-58629

### SUMMARY OF THE INVENTION

### Problems to be Solved by the Invention

However, in the X-Y stage disclosed in Patent Document 1, the pressing mechanism and the bearing mechanism are complicated in structure, so that there is a problem that it is difficult to downsize the X-Y stage.

In addition, the stage device disclosed in Patent Document 2 has a structure in which a first stage and a second stage are placed on each other, and accordingly, it is difficult to downsize the stage device even if ultrasonic motors are installed inside the stages; moreover, there is a problem that it is also difficult to assemble the stage device.

The present invention has been devised in view of the above described problems, and it is an object of the present invention to provide an ultrasonic motor device which is easy to downsize and superior in assembling workability.

To solve the above described problems and achieve the object, the ultrasonic motor device according to the present invention is characterized in that it includes a first ultrasonic motor unit and a second ultrasonic motor unit each of which includes: a vibrator which periodically vibrates by an application of a high-frequency voltage to the vibrator; a case which contains the vibrator; a moving member which is in contact with the vibrator; and a biasing member which applies a pressing force to the moving member and the vibrator to bring the moving member and the vibrator into pressing contact with each other, thereby producing a pressing force. The ultrasonic motor device further includes: a base member to which the case of the first ultrasonic motor unit is fixed; a first frame which is fixed to the moving member of the first ultrasonic motor unit and to which the case of the second ultrasonic motor unit is fixed; and a second frame which is fixed to the moving member of the second ultrasonic motor unit.

In the ultrasonic motor device according to the present invention, it is desirable that two of the first ultrasonic motor units as a pair be positioned on the base member to face each other.

In the ultrasonic motor device according to the present invention, it is desirable that two of the second ultrasonic motor units as a pair be positioned on the first frame to face each other.

In the ultrasonic motor device according to the present invention, it is desirable that the first ultrasonic motor unit be one in number.

In the ultrasonic motor device according to the present invention, it is desirable that the second ultrasonic motor unit be one in number.

### EFFECTS OF THE INVENTION

The ultrasonic motor device according to the present invention attains an effect of easily reducing the size of the ultrasonic motor device and an effect of achieving a high assembling workability.

### BRIEF DESCRIPTION OF THE DRAWINGS

FIG. 1 is a perspective view showing the structure of an ultrasonic motor device according to a first embodiment of the present invention;

FIG. 2 is an exploded perspective view showing the structure of the ultrasonic motor device according to the first embodiment of the present invention;

FIG. 3 is an exploded perspective view for illustrating operations of an X-plate according to the first embodiment of the present invention;

FIG. 4 is an exploded perspective view for illustrating operations of a Y-plate according to the first embodiment of the present invention;

FIG. 5 is an exploded perspective view showing the structural example of an ultrasonic motor unit according to the first embodiment of the present invention;

FIG. 6 is a perspective view showing a structural example of the ultrasonic motor unit according to the first embodiment of the present invention;

FIG. 7 is a perspective view showing the structure of an ultrasonic motor device according to a second embodiment of the present invention;

FIG. 8 is an exploded perspective view showing the structure of the ultrasonic motor device according to the second embodiment of the present invention; and

FIG. 9 is an exploded perspective view showing the structure of a bearing member according to the second embodiment of the present invention.

### EMBODIMENTS

Embodiments of an ultrasonic motor device according to the present invention will be hereinafter discussed in detail with reference to the accompanying drawings. Note that the present invention is not limited by the embodiments described below.

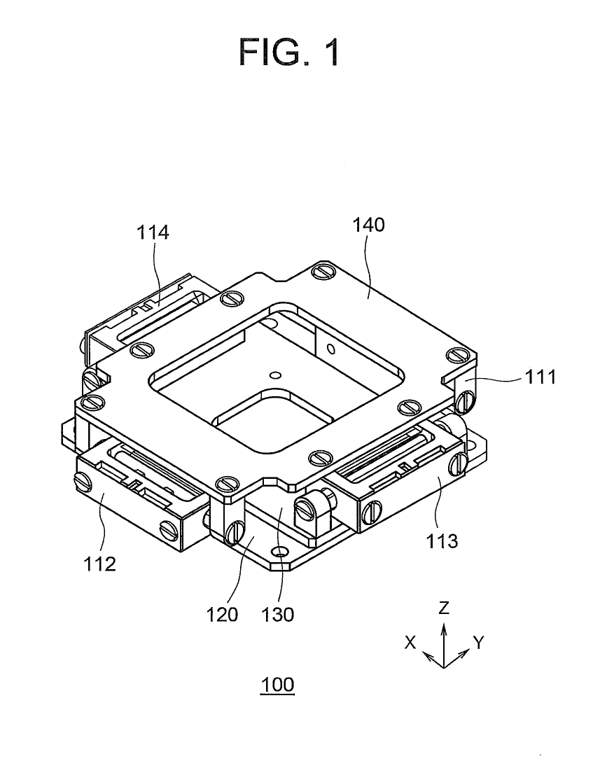

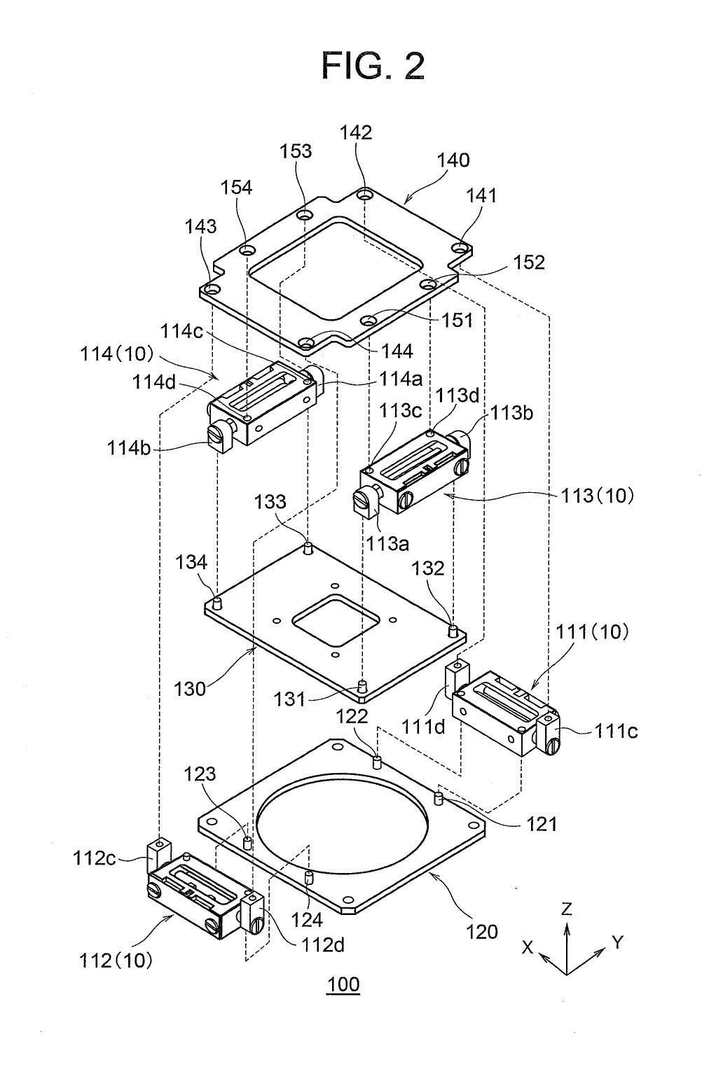

First, an ultrasonic motor device according to a first embodiment will be hereinafter discussed with reference to FIGS. 1 through 6. FIG. 1 is a perspective view showing the structure of the ultrasonic motor device according to the first embodiment. FIG. 2 is an exploded perspective showing the structure of the ultrasonic motor device according to the first embodiment.

As shown in FIGS. 1 and 2, the ultrasonic motor device 100 of the first embodiment is provided with ultrasonic motor units 111 and 112 (first ultrasonic motor units) for X-axis driving, ultrasonic motor units 113 and 114 (second ultrasonic motor units) for Y-axis driving, a plate-shaped base 120, an X-plate 140 (first frame) and a Y-plate 130 (second frame).

The ultrasonic motor units 111 and 112 are fixed to both ends of the upper surface of the base 120 in a Y-direction, respectively, so as to face each other to serve as a pair. Specifically, a case member (case) of the ultrasonic motor unit 111 is secured to mounting portions 121 and 122 of the base 120 by screws and a case member (case) of the ultrasonic motor unit 112 is secured to mounting portions 123 and 124 of the base 120 by screws.

Additionally, the ultrasonic motor unit 111 is provided with a driven member (moving member) movable along an X-axis direction, and this driven member is provided at both ends thereof with connecting members 111c and 111d, respectively. Likewise, the ultrasonic motor unit 112 is provided with a driven member (moving member) movable along the X-axis direction, and this driven member is provided at both ends thereof with connecting members 112c and 112d, respectively.

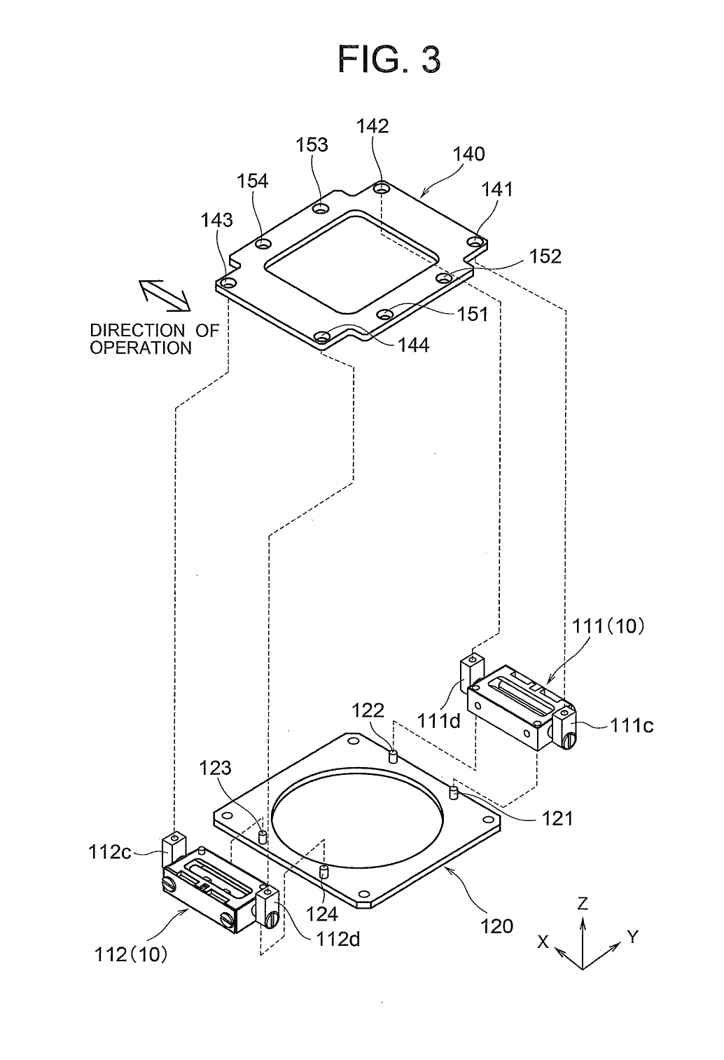

The X-plate 140 is provided at one end thereof in the Y-direction with mounting holes 141 and 142 and provided at the other end of the X-plate 140 in the Y-direction with mounting holes 143 and 144. The ultrasonic motor unit 111 is joined to a lower surface of the X-plate 140 with the connecting members 111c and 111d respectively secured to the mounting holes 141 and 142 by screws. In addition, the ultrasonic motor unit 112 is joined to a lower surface of the X-plate 140 with the connecting members 112c and 112d respectively secured to the mounting holes 143 and 144 by screws. As a result, the ultrasonic motor units 111 and 112 are positioned to face each other in a manner to support the X-plate 140 at both ends thereof in the Y-direction (FIGS. 2 and 3). FIG. 3 is an exploded perspective view for illustrating operations of the X-plate 140, and components such as the Y-plate 130 that are shown in FIG. 2 are not shown in FIG. 3.

In the structure shown in FIG. 3, operations of the ultrasonic motor units 111 and 112 cause the driven members thereof to move in the X-direction, respectively. Consequently, the connecting members 111c and 111d of the ultrasonic motor unit 111 move in the X-direction and the connecting members 112c and 112d of the ultrasonic motor unit 112 move in the X-direction, which causes the X-plate 140 to move in the X-direction.

On the other hand, the ultrasonic motor units 113 and 114 are fixed to both ends of the lower surface of the X-plate 140 in the X-direction, respectively, so as to face each other to serve as a pair. Specifically, the ultrasonic motor unit 113 is secured to the lower surface of the X-plate 140 by screwing a case member (case) thereof to mounting portions 151 and 152 of the X-plate 140 via screw holes 113c and 113d. Additionally, the ultrasonic motor unit 114 is secured to the lower surface of the X-plate 140 by screwing a case member (case) thereof to mounting portions 153 and 154 of the X-plate 140 via screw holes 114c and 114d. As a result, the ultrasonic motor units 113 and 114 are positioned to face each other in a manner to hang from the X-plate 140 at both ends thereof in the X-direction.

In addition, the ultrasonic motor unit 113 is provided with a driven member (moving member) movable along the Y-axis direction, and this driven member is provided at both ends thereof with connecting members 113a and 113b, respectively. Likewise, the ultrasonic motor unit 114 is provided with a driven member (moving member) movable along the Y-axis direction, and this driven member is provided at both ends thereof with connecting members 114a and 114b, respectively.

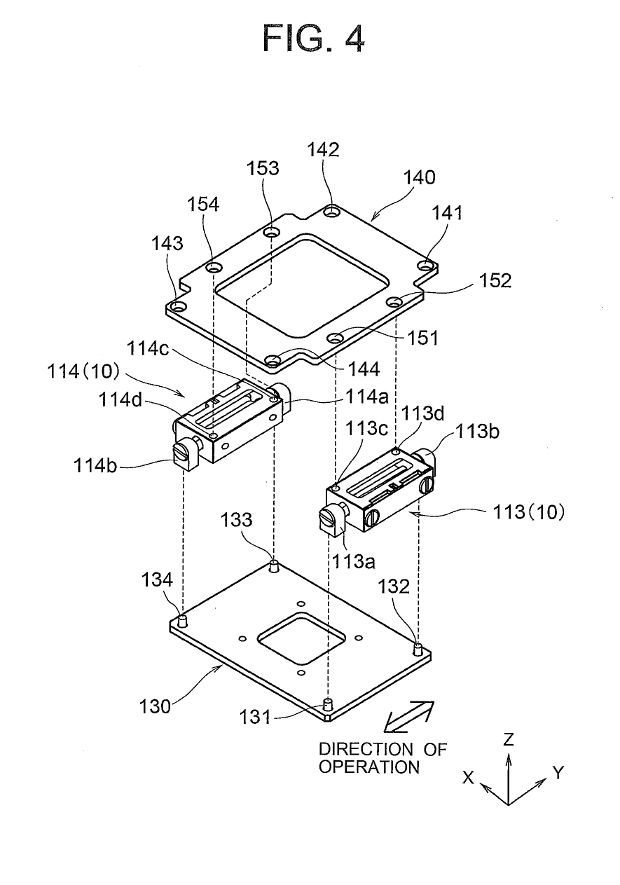

The Y-plate 130 is provided at one end thereof in the X-direction with mounting portions 131 and 132 and provided at the other end of the Y-plate 130 in the X-direction with mounting portions 133 and 134. The ultrasonic motor unit 113 is joined to an upper surface of the Y-plate 130 with the connecting members 113a and 113b respectively secured to the mounting portions 131 and 132 by screws. In addition, the ultrasonic motor unit 114 is joined to an upper surface of the Y-plate 130 with the connecting members 114a and 114b respectively secured to the mounting portions 133 and 134 by screws. As a result, the ultrasonic motor units 113 and 114 are positioned to face each other in a manner to support the Y-plate 130 at both ends thereof in the X-direction (FIGS. 2 and 4). FIG. 4 is an exploded perspective view for illustrating operations of the Y-plate 130, and components such as the X-plate 140 that are shown in FIG. 2 are not shown in FIG. 4.

In the structure shown in FIG. 4, operations of the ultrasonic motor units 113 and 114 cause the driven members thereof to move in the Y-direction, respectively. Consequently, the connecting members 113a and 113b of the ultrasonic motor unit 113 move in the Y-direction and the connecting members 114a and 114b of the ultrasonic motor unit 114 move in the Y-direction, which causes the Y-plate 130 to move in the Y-direction.

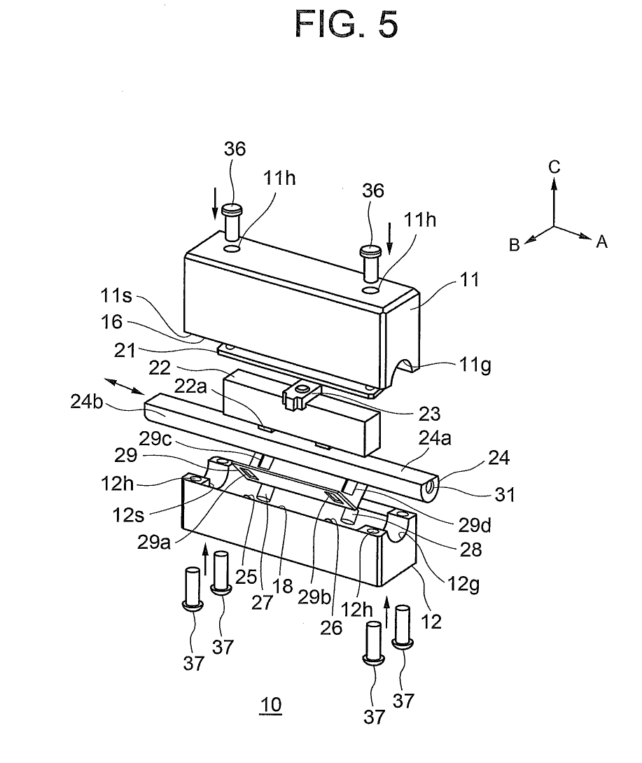

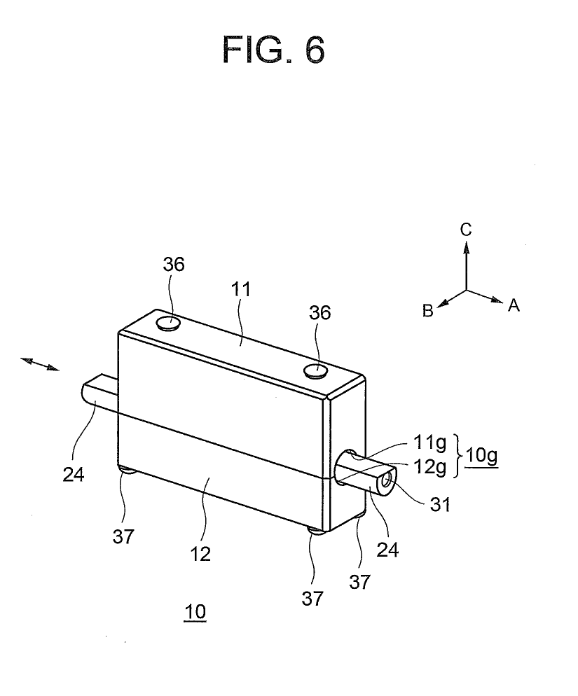

As each of the ultrasonic motor units 111, 112, 113 and 114, for instance, a linear drive ultrasonic motor unit 10 shown in FIGS. 5 and 6 can be used. FIG. 5 is an exploded perspective view showing a structural example of an ultrasonic motor unit according to the first embodiment of the present invention. FIG. 6 is a perspective view showing a structural example of the ultrasonic motor unit according to the first embodiment of the present invention.

In the case of being applied to the ultrasonic motor 111 or the ultrasonic motor unit 112, the ultrasonic motor unit 10 shown in FIGS. 5 and 6 is used with the connecting members 111c and 111d or the connecting members 112c and 112d fixed to both ends of a driven member 24 (moving member), respectively. In this case, ultrasonic motor unit 10 is positioned so that an A-direction in which the driven member 24 is elongated, the height direction (C-direction) and the thickness direction (B-direction) extend along the X-direction, the Y-direction and the Z-direction, respectively.

Additionally, in the case of being applied to the ultrasonic motor unit 113 or the ultrasonic motor 114, ultrasonic motor unit 10 is used with the connecting members 113a and 113b or the connecting members 114a and 114b fixed to both ends of a driven member 24 (moving member), respectively. In this case, ultrasonic motor unit 10 is positioned so that the A-direction, in which the driven member 24 is elongated, the height direction (C-direction) and the thickness direction (B-direction) extend along the Y-direction, the X-direction and the Z-direction, respectively.

The ultrasonic motor unit 10 (linear drive ultrasonic motor) that is shown in FIGS. 5 and 6 will be discussed hereinafter.

As shown in FIG. 5, the ultrasonic motor unit 10 is provided with a vibrator 22 (vibration member) as an ultrasonic vibrator, a driven member 24, a pressing member 21 (biasing member), a first case member 11, rolling members 25, 26, 27 and 28 as a guide device, and a second case member 12. The vibrator 22, the first case member 11 (case) and the second case member 12 (case) each have a substantially rectangular prism outside shape, a first accommodating recess 16 is formed in the first case member 11, and a second accommodating recess 18 is formed in the second case member 12.

In the first accommodating recess 16, the vibrator 22 and the pressing member 21 are accommodated in that order from the opening side (an end surface 11s side) in the height direction (the C-direction in FIG. 5) of the ultrasonic motor unit 10. The pressing member 21 is a long-plate-shaped leaf spring and positioned so that the lengthwise direction thereof extends along the lengthwise direction (the A-direction in FIG. 5) of the ultrasonic motor unit 10 and the first case member 11. On the other hand, in the second accommodating recess 18, the guide member 29 and the rolling members 25, 26, 27 and 28 are accommodated in that order from the opening side (an end surface 12s side) in the height direction (the C-direction in FIG. 5) of the ultrasonic motor unit 10. The rolling members 25, 26, 27 and 28 are arranged in two rows along the lengthwise direction of the second case member 12 with each row including two rolling members.

The guide member 29 has a shape such that a long-plate-shaped member is bent in the widthwise center thereof. The guide member 29 is provided, at positions corresponding to the rolling members 25, 26, 27 and 28 when the guide member 29 is accommodated in the second accommodating recess 18 so that the bent portion is positioned inside of the second case member 12, with guide holes 29a, 29b, 29c and 29d formed as through holes, respectively. It is desirable that the position of the guide member 29 be fixed by engagement with an engaging portion (not shown) provided inside of the second accommodating recess 18. With this structure, in the second accommodating recess 18 of the second case member 12, the four rolling members 25, 26, 27 and 28 are located to be capable of rolling with being fitted upwardly into the guide holes 29a, 29b, 29c and 29d from below, respectively.

The driven member 24 (moving member) is a shaft member having a D-shape in cross section. When the first case member 11 and the second case member 12 are put together, a plane portion 24a is in contact with vibrator 22 via drivers 22a while a curved surface portion 24b is in contact with the rolling members 25, 26, 27 and 28.

The first case member 11 and the second case member 12 are put together with the end surface 11s of the first accommodating recess 16 and the end surface 12s of the second accommodating recess 18 in contact with each other. This operation is performed by screwing case setscrews 37 into screw holes 12h formed in the second case member 12.

A first groove 11g is formed on the end surface 11s of the first accommodating recess 16 along the direction (the A-direction) in which the driven member 24 is driven. On the other hand, a second groove 12g is formed on the end surface 12s of the second accommodating recess 18 to correspond to the first groove 11g when the first case member 11 and the second case member 12 are put together. Upon the first case member 11 and the second case member 12 being put together, the first groove 11g and the second groove 12g are positioned to face each other to form an opening 10g. The driven member 24 extends toward the outside of the first case member 11 and the second case member 12 through the opening 10g.

On the other hand, in the first case member 11 and the second case member 12, the driven member 24 is in contact with and supported by the rolling members 25, 26, 27 and 28 that project upward from the guide holes 29a, 29b, 29c and 29d of the guide member 29, respectively. By being supported by the rolling members 25, 26, 27 and 28, which are arranged along the lengthwise direction of the second case member 12, the driven member 24 becomes capable of moving along the lengthwise direction of the case member 12, i.e., the lengthwise direction of the driven member 24.

Upper surfaces of the pressing member 21 at both ends thereof in the lengthwise direction can be pressed by pressing screws 36 (press members), respectively. The pressing screws 36 are respectively inserted into screw holes 11h that are formed through the top of the first case member 11 as through holes so that the ends of the pressing screws 36 extend into the inside of the first accommodating recess 16. In addition, the pressing member 21 is positioned so that the lower surface of a center portion thereof in the lengthwise direction of the pressing member 21 is in contact with a support member 23 of the vibrator 22 that is for positioning. Here, the support member 23 is fixed to the center of the vibrator 22 in the lengthwise direction thereof (the A-direction shown in FIG. 5). Additionally, the vibrator 22 is composed of an ultrasonic vibrator (e.g., a piezoelectric element). Since a method of driving a piezoelectric element is known in the art, the electrical wiring for driving the vibrator 22 is omitted from the drawings which will be noted below. Additionally, the first case member 11 is provided in the first accommodating recess 16 with an engaging groove (not shown) in which an overhang of the support member 23 is engaged.

The ultrasonic motor unit 10 that has the above described structure is assembled in the following manner.

First, the pressing member 21 is inserted into the first accommodating recess 16 of the first case member 11. Subsequently, the first case member 11 is fixed to the vibrator 22 by making the overhang of the support member 23 and the engaging groove of the first case member 11 engaged with each other.

Subsequently, the first case member 11 and the second case member 12 are mounted to each other with the case setscrews 37 installed from the second case member 12 side that is in a state of supporting the driven member 24 via the rolling members 25, 26, 27 and 28. In addition, after this mounting operation, the pressing force by the pressing member is set to a desired value by adjusting the amount of projection of each pressing screw 36 into the first accommodating recess 16. After this adjustment of the pressing force, for instance, the pressing screws 36 can be fixed to the screw holes 11h of the first case member 11 by an adhesive. The adjustment of the pressing force can be made by making a change to the material of the pressing member 21 or the shape thereof.

The first case member 11 has a rigidity sufficiently greater than that the pressing member 21 has, so that, e.g., the amount of warping of the pressing member 21 does not change even if the first case member 11 contacts a member(s) of an external device not shown in the drawings. This improves the degree of freedom in design of the external device. In addition, since the pressing member 21 is not exposed outside of the first case member 11, an external surface of the first case member 11 can be used for the positioning of the first case member 11 by making the external form abut on the external device when the first case member 11 is installed.

In the above described structure, a frictional force is produced between the vibrator 22 and the driven member 24 by pressure of the pressing member 21 on the vibrator 22 against the driven member 24. Accordingly, the driven member 24 moves in the lengthwise direction thereof by making the vibrator 22 vibrate by an application of a high frequency voltage to the vibrator 22. Additionally, since the driven member 24 moves while being supported by the rolling members 25, 26, 27 and 28, a stable pressing force is obtained.

As shown in FIGS. 5 and 6, the driven member 24 is provided at both ends thereof with two coupling portions 31, respectively, which makes a linearly movable device possible.

More specifically, taking the ultrasonic motor unit 111 shown in FIGS. 1 and 2 as an example, a movement of the driven member 24 in the A-direction upon the driven member 24 being driven causes the X-plate 140 to move in the X-direction if the connecting members 111c and 111d are respectively fixed to both ends of the driven member 24 and also to the X-plate 140. Such structure and operation are also the same for the ultrasonic motor unit 112.

Additionally, as for the ultrasonic motor unit 113, a movement of the driven member 24 in the A-direction upon the driven member 24 being driven causes the Y-plate 130 to move in the Y-direction if the connecting members 113a and 113b are respectively fixed to both ends of the driven member 24 and also to the Y-plate 130. Such structure and operation are also the same for the ultrasonic motor unit 114.

Accordingly, in the ultrasonic motor device 100, the X-plate 140 is movable relative to the base 120 by driving the ultrasonic motor units 111 and 112, and the Y-plate 130 is movable relative to the X-plate 140 by driving the ultrasonic motor units 113 and 114.

The ultrasonic motor device 100 that has the above described structure and action attains the following effects.

An X-Y stage capable of being driven in the X and Y directions with stability can be provided simply by installation of the ultrasonic motor units 111, 112, 113 and 114 that are stable in characteristics.

In other words, the pressing force, the drive frequency and others have been formerly adjusted after the installation of ultrasonic motor units to an X-Y stage; however, in the ultrasonic motor device 100, it is possible to do installation of an X-Y stage with ultrasonic motor units the motor characteristics of which have been optimally adjusted with each ultrasonic motor unit separate from the X-Y stage, which makes it possible to downsize the X-Y stage and improve the assembling workability thereof. Examples of the motor characteristics to be adjusted include a pressing force and a drive frequency.

### Second Embodiment

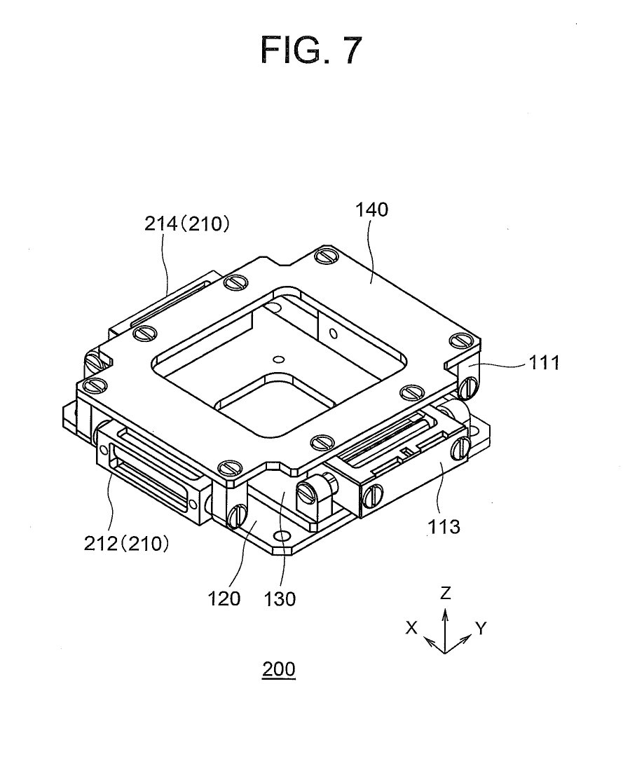

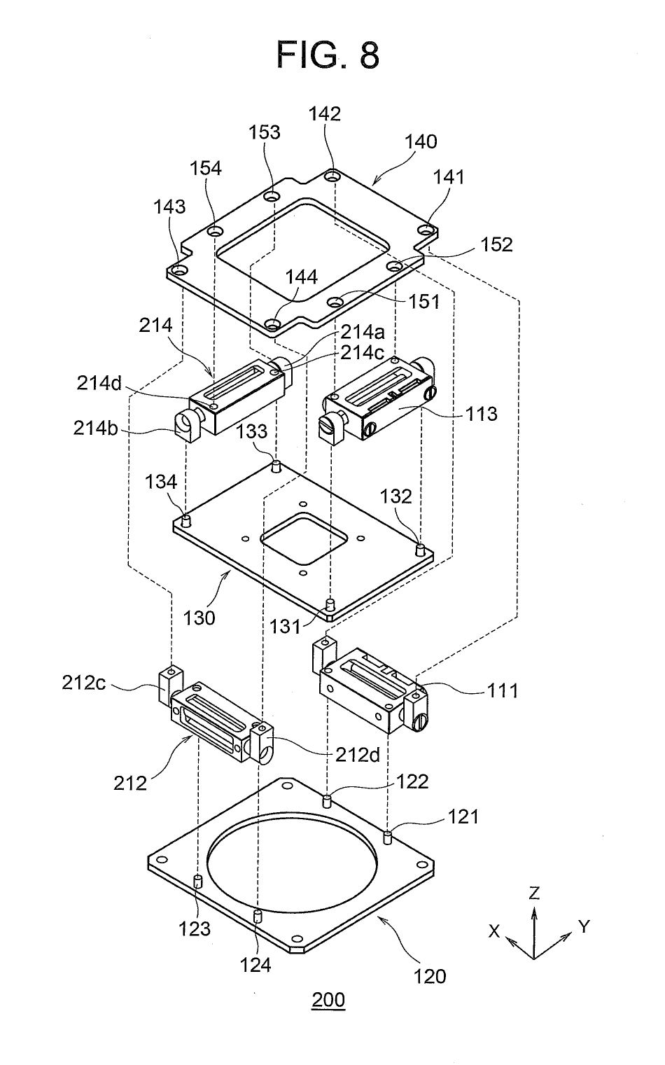

An ultrasonic motor device according to a second embodiment will be hereinafter discussed with reference to FIGS. 7 through 9. FIG. 7 is a perspective view showing the structure of the ultrasonic motor device 200 according to the second embodiment. FIG. 8 is an exploded perspective view showing the structure of the ultrasonic motor device 200 according to the second embodiment.

As shown in FIGS. 7 and 8, the ultrasonic motor device 200 according to the second embodiment is different from the ultrasonic motor device 100 according to the first embodiment in that bearing members 212 and 214 are used instead of the ultrasonic motor units 112 and 114 of the first embodiment. The structure of the remaining part is the same as that in the ultrasonic motor device 100 according to the first embodiment, so that components corresponding to those in the ultrasonic motor device 100 according to the first embodiment are designated by the same reference numerals.

In the ultrasonic motor device 200, the X-plate 140 and the Y-plate 130 are each driven by a single ultrasonic motor unit. In other words, the ultrasonic motor device 200 is equipped with an ultrasonic motor unit 111 for moving the X-plate 140 and an ultrasonic motor unit 113 for moving the Y-plate 130.

Similar to the ultrasonic motor unit 112, the bearing member 212 is fixed to an end of the upper surface of the base 120 in the Y-direction so that the bearing member 212 and the ultrasonic motor unit 111 face each other to serve as a pair. In addition, a case member (case) of the bearing member 212 is secured to the mounting portions 123 and 124 of the base 120 by screws.

Additionally, the bearing member 212 is provided with a shaft member movable along the X-axis direction, and connecting members 212c and 212d are fixed to both ends of this shaft member, respectively. The bearing member 212 is joined to a lower surface of the X-plate 140 with the connecting members 212c and 212d respectively secured to the mounting holes 143 and 144 by screws. As a result, the ultrasonic motor unit 111 and the bearing member 212 are positioned to face each other in a manner to support the X-plate 140 at both ends thereof in the Y-direction. Here it is desirable that the case member of the bearing member 212 be identical at least in thickness (size in the Z-direction) to the ultrasonic motor unit 111.

On the other hand, similar to the ultrasonic motor unit 114, the bearing member 214 is fixed to an end of the lower surface of the X-plate 140 in the X-direction so that the bearing member 214 and the ultrasonic motor unit 113 face each other to serve as a pair. Specifically, a case member (case) of the bearing member 214 is secured to the mounting portions 153 and 154 of the X-plate 140 by screws. As a result, the ultrasonic motor unit 113 and the bearing member 214 are positioned to face each other in a manner to hang from the X-plate 140 at both ends thereof in the X-direction.

Additionally, the bearing member 214 is provided with a shaft member movable along the Y-axis direction, and connecting members 214a and 214b are fixed to both ends of this shaft member, respectively. The bearing member 214 is joined to an upper surface of the Y-plate 130 with the connecting members 214a and 214b respectively secured to the mounting portions 133 and 134 by screws. As a result, the ultrasonic motor unit 113 and the bearing member 214 are positioned to face each other in a manner to support the Y-plate 130 at both ends thereof in the X-direction. Here it is desirable that the case member of the bearing member 214 be identical at least in thickness (size in the Z-direction) to the ultrasonic motor unit 113.

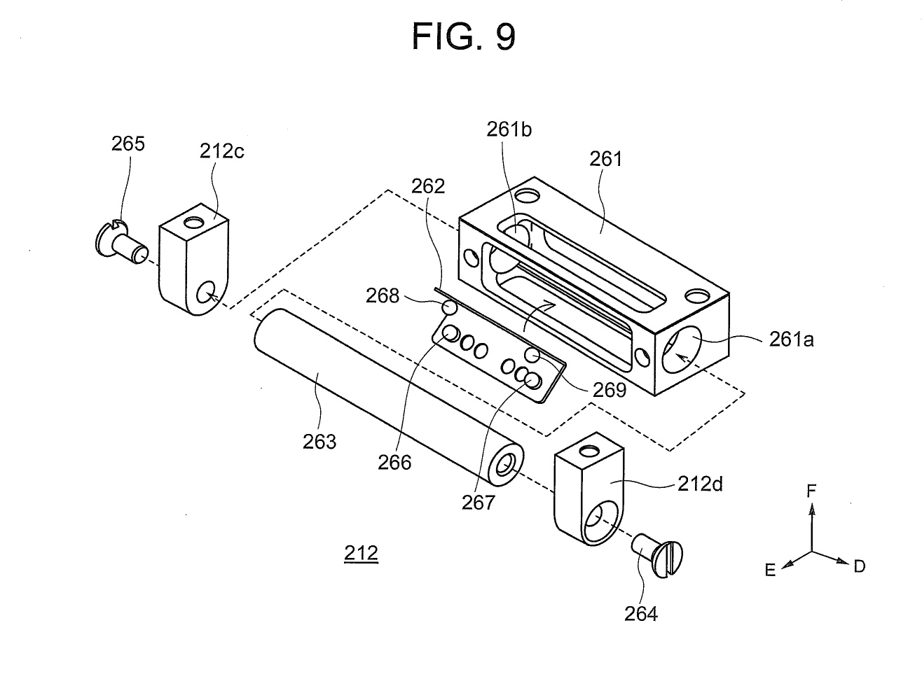

Now the structure of the bearing member 212 and 214 will be hereinafter discussed with reference to FIG. 9. FIG. 9 is an exploded perspective view showing the structure of a bearing member according to the second embodiment. The bearing member 212 and 214 are identical in shape in the second embodiment, and accordingly, only the bearing member 212 is described in FIG. 9. The bearing member 212 and the bearing member 214 can be made mutually difference in shape if capable of achieving the same action and effect.

The bearing member 212 is provided with a case 261, a guide member 262, a shaft member 263 and rolling members 266, 267, 268 and 269.

The case 261 is hollow and has a substantially rectangular outside shape, and openings 261a and 261b are formed through side walls of the case 261 which face each other.

The guide member 262 has a shape such that a long-plate-shaped member is bent in the widthwise center thereof. The guide member 262 is provided at predetermined positions with a plurality of guide holes which extend through the guide member 262 in the direction of the thickness thereof, and the spherical rolling members 266, 267, 268 and 269 are respectively supported by the guide holes to be capable of rolling thereat. The guide member 262 is placed in the internal space of the case 261.

In the case 261, the shaft member 263 is placed on the rolling members 266, 267, 268 and 269. The shaft member 263 is positioned so that both ends thereof project outwardly from the openings 261a and 261b, respectively, and connecting members 212c and 212d are fixed to both ends of the shaft member 263, respectively. The connecting members 212c and 212d are fixed to both ends of the shaft member 263 by screws 264 and 265. The shaft member 263 is held by the rolling members 266, 267, 268 and 269 to be movable in the axial direction (D-direction).

The bearing member 212 is positioned so that the D-direction, along which the shaft member 263 is elongated, extends along the X-direction, so that the height direction (E-direction) extends along the Y-direction, and so that the thickness direction (F-direction) extends along the Z-direction. On the other hand, the bearing member 214 is positioned so that the D-direction, along which the associated shaft member is elongated, extends along the Y-direction, so that the height direction (E-direction) extends along the X-direction, and so that the thickness direction (F-direction) extends along the Z-direction.

In the ultrasonic motor device 200, the number of ultrasonic motor units can be reduced since the bearing members 212 and 214 are used instead of the ultrasonic motor units 112 and 114. Accordingly, adopting such a structure makes it possible to achieve a reduction in cost when the load required to move the X-plate and the Y-plate is small.

The structure, action and effect of the remaining part are the same as those in the first embodiment.

### INDUSTRIAL APPLICABILITY

As described above, the ultrasonic motor device according to the present invention is useful in an X-Y stage and a vibration-proofing structure for precision instruments.

### DESCRIPTION OF THE REFERENCE NUMERALS

10 ultrasonic motor unit
10g opening
11 first case member (case)
11g first groove
11h screw hole
11s end surface
12 second case member (case)
12g second groove
12h screw hole
16 first accommodating recess
18 second accommodating recess
21 pressing member (biasing member)
22 vibrator (vibrating member)
22a driver
23 support member
24 driven member (moving member)
24a plane portion
24b curved surface portion
25, 25, 27, 28 rolling member (guide device)
29 guide member
29a, 29b, 29c, 29d guide hole
31 coupling portion
36 pressing screw (press member)
37 case setscrew
100 ultrasonic motor device
111 ultrasonic motor unit
111c, 111d connecting member
112 ultrasonic motor unit
112c, 112d connecting member
113 ultrasonic motor unit
113a, 113b connecting member
113c, 113d screw hole
114 ultrasonic motor unit
114a, 114b connecting member
114c, 114d screw hole
120 base
121, 122, 123, 124 mounting portion
130 Y-plate
131, 132, 133, 134 mounting portion
140 X-plate
141, 142, 143, 144 mounting hole
151, 152, 153, 154 mounting hole
200 ultrasonic motor device
212 bearing member
212c, 212d connecting member
214 bearing member
214a, 214b connecting member
214c, 214d screw hole
261 case
261a, 261b opening
262 guide member
263 shaft member
266, 267, 268, 269 rolling member

1. An ultrasonic motor device comprising:
a first ultrasonic motor unit and a second ultrasonic motor unit each of which includes: a vibrator which periodically vibrates by an application of a high frequent voltage to the vibrator; a case which accommodates the vibrator; a moving member which is in contact with the vibrator; and a biasing member which applies a pressing force to the moving member and the vibrator to bring the moving member and the vibrator into pressing contact with each other, thereby producing a pressing force;
a base member to which the case of the first ultrasonic motor unit is fixed;
a first frame which is fixed to the moving member of the first ultrasonic motor unit and to which the case of the second ultrasonic motor unit is fixed; and
a second frame which is fixed to the moving member of the second ultrasonic motor unit.

2. The ultrasonic motor device according to claim 1, wherein two of the first ultrasonic motor units as a pair are positioned on the base member to face each other.

3. The ultrasonic motor device according to claim 1, wherein two of the second ultrasonic motor units as a pair are positioned on the first frame to face each other.

4. The ultrasonic motor device according to claim 1, wherein the first ultrasonic motor unit is one in number.

5. The ultrasonic motor device according to claim 1, wherein the second ultrasonic motor unit is one in number.
